(19) United States
(12) Patent Application Publication
(10) Pub. No.: US 2024/0247799 A1
(43) Pub. Date: Jul. 25, 2024

(54) RECOVERY AND REUSE OF HIGH-PRESSURE BOILERS AND HEAT RECOVERY STEAM GENERATORS BLOWDOWN USING MICROWAVE ENERGY IRRADIATION

(71) Applicant: SAUDI ARABIAN OIL COMPANY, Dhahran (SA)

(72) Inventors: Mohamud M. Farah, Ras Tanura (SA); Mohammed A. Qahtani, Dhahran (SA)

(73) Assignee: SAUDI ARABIAN OIL COMPANY, Dhahran (SA)

(21) Appl. No.: 18/158,598

(22) Filed: Jan. 24, 2023

(51) Int. Cl. F22D 11/00; C02F 9/00

(52) U.S. Cl. CPC F22D 11/006; C02F 9/00; H05B 6/804

(57) ABSTRACT

A system and method for continuously treating blowdown water derived from one or more boilers using a microwave reactor, a cooling system, and an ion exchange filter to remove insoluble solids, organic matter, bacteria, and other impurities. The recovered water is stored, treated with a corrosion inhibitor, an oxidizing biocide, a non-oxidizing biocide, and a scale inhibitor, before being recycled for reuse in the boiler system.

### BACKGROUND

Boiler systems are ubiquitous in many oil and gas production facilities. The boilers are used to produce steam that is used across the plant for process requirements. Boilers evaporate liquid water to yield steam. Continuous production of steam involves an ongoing introduction of boiler feed water to the boilers. Boiler feed water is heated in each boiler through an exchange of heat. The heat source can vary with the type of boiler.

Over time, as steam is produced in a boiler, the concentration of dissolved impurities in the boiler increases, diminishing steam production due at least in part to scale deposits on heat exchange surfaces. Impurities, such as high total dissolved solids, silica and organic fouling, tend to impact the integrity of the boiler tubes, causing both scaling and corrosion issues. Boiler blowdown involves removing water from a boiler to expel some of the dissolved impurities, avoiding precipitation of solids in the boiler. The water blown out of the boiler (“blowdown water”) is typically expelled with force by steam pressure within the boiler and processed as wastewater. Conventional blowdown designs used in industry typically route the blowdown water into one or more sumps, where neutralization is performed before being discharged to either disposal or evaporation pits.

Recycling has been proposed as an alternative to discharge of blowdown water. For example, blowdown water can be recycled to feedwater conditioning using a conventional coagulation-precipitation process. Coagulation-precipitation processes typically use lime softening, weak acid cations, or strong acid cations. The processes precipitate portions of impurities such as magnesium, calcium and silica scales. Alternatively, WO 2015/054773 describes heating the blowdown water to the supercritical range, and US 2013/0292115 A1 describes a combination of precipitation and centrifugation. However, despite ongoing efforts to recycle blowdown water, there exists a need for strategies that can contribute to the cost effective reuse of blowdown water especially in the oil and gas industry.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for treating blowdown water from one or more boilers using a microwave reactor. A cooler is in fluid communication with the microwave reactor and cools the fluid from the reactor before being fed to a filter.

In another aspect, embodiments disclosed herein relate to a method for treating water. The method includes receiving blowdown water from one or more boilers containing an impurity. The reactor exposes the blowdown water to microwave radiation, producing a vapor that is then cooled to produce microwaved water. The microwaved water is filtered to produce recovered water containing a reduced amount of the impurity relative to the blowdown water.

In another aspect, embodiments disclosed herein relate to a method for continuously removing blowdown water from a boiler system having one or more combustion boilers and one or more heat recovery steam generators. The blowdown water contains impurities including iron salts, ionic silica, a phosphate scale inhibitor, a polymeric conditioner, and/or bacteria. The blowdown water is exposed to microwave radiation in the reactor, causing the precipitation of some of these impurities and vaporization of the water. The vapor is cooled to produce a liquid water in the blowdown cooler before passing through an ion exchange filter to remove more of the impurities and produce recovered water. The recovered water is stored and treated with a corrosion inhibitor, an oxidizing biocide, a non-oxidizing biocide, and a scale inhibitor. This treated, recovered water is then recycled to the boiler system.

Other aspects and advantages of the claimed subject matter will be apparent from the following description and the appended claims.

### BRIEF DESCRIPTION OF DRAWINGS

FIG. 1 is a schematic diagram of a blowdown treatment system, in accordance with one or more embodiments.

FIG. 2 is a schematic diagram of a comparative blowdown treatment system, in accordance with one or more embodiments.

FIG. 3 is a graph of blowdown flow rates, in accordance with one or more embodiments.

### DETAILED DESCRIPTION

Embodiments disclosed herein relate to the recovery and reuse of blowdown water from one or more boilers a using microwave heat irradiation of the blowdown water to remove impurities, followed by filtering to remove breakthrough impurities. The reuse may be recycling the breakdown water to at least one of the one or more boilers as feedwater. Cost-saving may be achieved due to the resulting reduction of raw water consumption for feedwater.

In one aspect, embodiments disclosed herein relate to a system for treating blowdown water derived from one or more boilers that includes a microwave reactor configured to receive the blowdown water and a filter in fluid communication with the microwave reactor. A cooler may be disposed between and in fluid communication with the microwave reactor and the filter.

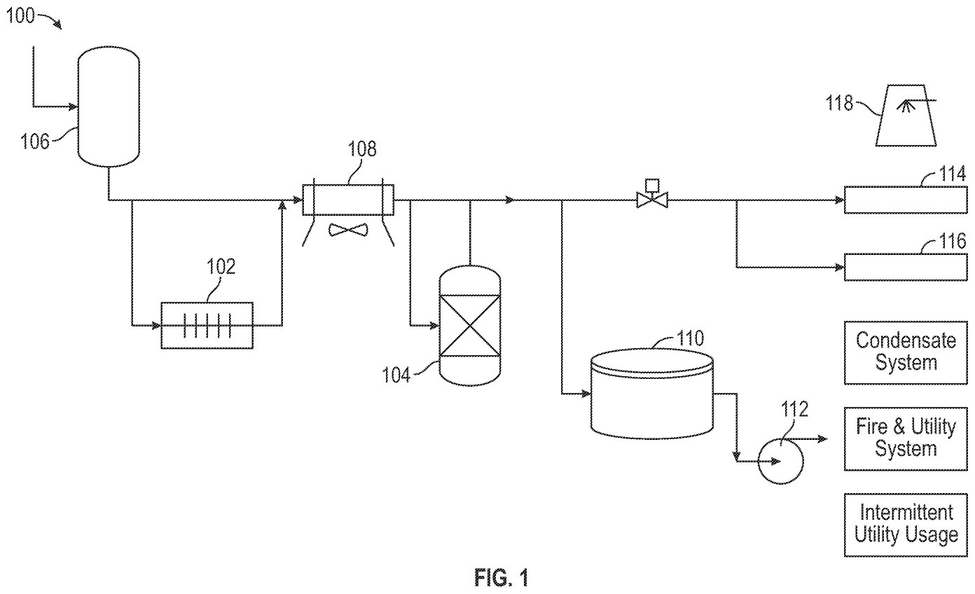

FIG. 1 shows blowdown treatment system 100 including microwave reactor 102 and filter 104. Blowdown treatment system 100 further includes separator 106, cooler 108, storage tank 110, chemical treatment subsystem 112, cooling water basin 114, and sump 116, and cooling tower 118. Microwave reactor 102 is configured to receive blowdown water from one or more boilers (not shown); cooler 108 is in fluid communication with microwave reactor 102; and filter 104 in fluid communication with cooler 108.

In one or more embodiments, microwave reactor 102 is capable of producing microwave radiation. Microwave radiation is electromagnetic ultrahigh-frequency radiation, including decimeter (dcm), centimeter (cm), and millimeter (mm) ranges of radio waves with a frequency of 0.3 GHz to 300 GHz, corresponding to a wavelength from 1 m to 1 mm. The microwave radiation may be high energy microwave radiation at 2450 MHz±50 MHz. Microwave reactor 102 may be a commercially available industrial microwave reactor, such as MWG20S from Advanced Environmental Technologies Limited; Puschnere Microwave Power Systems. Microwave reactor 102 may be capable of irradiating blowdown water in the microwave reactor with the microwave radiation. Industrial microwave reactors capable of receiving and irradiating fluids are known. For example, irradiation of wastewater and sludge has been described (CN107487956B, CN203247118U, CN101037244A, CN203021337U, CN102050532B, KR100541159B1) and irradiation of crude oil emulsions has been described (U.S. Pat. No. 5,911,885A, KR101975070B1, U.S. Pat. Nos. 4,582,629A, 8,314,157B2).

Microwave irradiation of blowdown water in microwave reactor 102 may produce microwave heating of the blowdown water. The microwave reactor may include a microwave source. The microwave heating may involve lack of contact between the microwave source and the blowdown water.

In one or more embodiments, filter 104 is an ion exchange column. The ion exchange column may include a strong base ion exchange resin. Strong base ion exchange resins are known and commercially available. For example, the strong basic ion exchange resin may be a Type 1, Type 2, acrylic, or microporous strong base ion exchange resin. The filter may be capable to filter one or more breakthrough impurities. The filter may be capable of filtering ionic silica.

In one or more embodiments, system 100 is in continuous fluid communication with the one or more boilers. In one or more embodiments, system 100 is in intermittent fluid communication with the one or more boilers.

In one or more embodiments, separator 106 is a blowdown separator. The blowdown separator may be a conventional blowdown separator as is known for use with blowdown treatment. In one or more embodiments, separator 106 is configured to receive the blowdown water from the one or more boilers, and microwave reactor 102 is configured to receive the blowdown water from the blowdown separator 106.

In one or more embodiments, cooler 108 is a blowdown cooler. The blowdown cooler may be a conventional blowdown cooler as is known for use with conventional blowdown treatment.

In one or more embodiments, the type of chemical treatment subsystem 112 may be dependent on the type of reuse of the recovered blowdown water. For closed loop cooling medium, chemical treatment subsystem 112 may include a chemical injection skid for nitrite corrosion inhibitors. For fire and utility system water, chemical treatment subsystem 112 may include an injector for injection of oxidizing biocide for microbiological control. For open loop cooling medium, chemical treatment subsystem 112 may include injection skids for injecting one or more of scale inhibitor, non-oxidizing biocide and corrosion inhibitor.

In one or more embodiments, cooling water basin 114 is a blowdown cooling water basin. The blowdown cooling water basin may be a conventional blowdown cooler as is known for use with conventional blowdown treatment.

In one or more embodiments, sump 116 is a blowdown sump. The blowdown sump may be a conventional blowdown sump as is known for use with conventional blowdown treatment.

In one or more embodiments, separator 106 is in fluid communication with the one or more boilers, microwave reactor 102 is in fluid communication with separator 106, cooler 108 is in fluid communication with microwave reactor 102, filter 104 is in fluid communication with cooler 108, storage tank 110 is in fluid communication with filter 104, chemical treatment subsystem 112 is in fluid communication with storage tank 110, cooling water bath 114 is in fluid communication with cooler 108, and sump 116 is in fluid communication with cooler 108. The fluid communication allows the flow of blowdown water through system 100 to become recovered water.

In one or more embodiments, the one or more boilers include a combustion boiler. The combustion boiler may implement an exchange of heat between burning fuel and boiler feedwater to generate steam from the feedwater. In one or more embodiments, the one or more boilers include a heat recovery steam generator. The heat recovery steam generator may implement an exchange of heat between a hot gas and boiler feedwater to generate steam from the boiler feedwater. The hot gas may be a gas that would otherwise be wasted. The hot gas may be generated by a turbine. In one or more embodiments, the one or more boilers include one or more combustion boilers and one or more heat recovery steam generators.

In one or more embodiments, the one or more boilers are part of an oil and gas facility. The oil and gas facility may utilize combustion gas turbine generator systems for the co-generation of power and steam. The steam generation process may use a heat recovery steam generator, where high temperature gases from the turbine are utilized to heat boiler feed water, generating high pressure steam that is directed to the common steam header for plant-wise use. The power generated from the turbines may be both used for plant consumption and transferred to the national grid.

In one or more embodiments, at least one boiler is a drum type boiler. In one or more embodiments, at least one boiler is a once through boiler. At least one boiler may be a high pressure boiler. A boiler that generates steam at a pressure of more than 15 psi. At least one boiler may be a low pressure boiler. A low pressure boiler generates steam at a pressure of 15 psi or less. Although typically once through boilers are associated with high pressure use, it will be understood that a drum type or once through boiler may be a high or a low pressure boiler.

In one or more embodiments, the boiler feedwater complies with parameters to facilitate protecting the integrity of the boiler system. The integrity of the boiler system may be diminished by for example one or more of corrosion, scale deposition, and impurity carryover. The parameters may include one or more of conductivity, pH, hardness, and alkalinity, amount of dissolved oxygen, amount of total dissolved solids, and amount of ionic silica.

In another aspect, embodiments disclosed herein relate to a method for treating water, including: receiving blowdown water from the one or more boilers, where the blowdown water includes an impurity; exposing the blowdown water to microwave radiation to produce a vapor; cooling the vapor to produce microwaved water; and filtering the microwaved water to produce recovered water, where the recovered water comprises a reduced amount of the impurity. The exposing may occur in microwave reactor 102. The cooling may occur in cooler 108. The filtering may occur in filter 104. The receiving may be continuous. The receiving may be intermittent. In one or more embodiments, the one or more boilers comprise one or more combustion boilers and one or more heat recovery steam generators.

In one or more embodiments, the impurity is selected from the group consisting of an iron salts, ionic silica, a phosphate scale inhibitor, a polymeric conditioner, a bacteria, and combinations thereof. In one or more embodiments, the exposing precipitates a portion of the impurity. In one or more embodiments, the exposing destroys bacteria in the impurity. In one or more embodiments, the filtering removes a portion of the impurity.

In one or more embodiments, exposing the blowdown water to microwave radiation effects microwave irradiation of the blowdown water. The microwave irradiation of the blowdown water may cause the blowdown water to heat, effecting microwave heating of the blowdown water. As compared to conventional electric heating of blowdown water, the microwave heating may be more rapid, have higher degree of uniformity, and more precise heating. The microwave heating may induce dipolar oscillations and ionic conductivity in the blowdown water. The microwave irradiation may achieve agglomeration and precipitation of insoluble solids in the blowdown water. The insoluble solids may include iron hydroxides, oxides, and phosphates. The iron hydroxides, oxides, phosphates are examples of iron salts.

In one or more embodiments, as described above, the microwave radiation is high energy microwave radiation. The high microwave energy may lead to destruction or removal of one or more impurities. The high microwave energy may lead to destruction or removal of organic matter arising from the chemical injection such as phosphate polymers. The process may achieve destruction or removal of organic matters arising from the use of phosphate polymer treatment, leading to low total organic carbon. The high microwave energy may lead to destruction or removal of any bacterial proliferation or growth in the blowdown water. The high microwave energy may lead to destruction or removal of dissolved solids. The high microwave energy may lead to destruction or removal of dissolved scale such arising from transition metals such as iron and silica. The destruction or removal of any one of the one or more impurities may be complete.

The filtering may remove breakthrough impurities that remain after exposing the blowdown water to microwave radiation. Strong-base ion exchange may be used to remove breakthrough impurities such as ionic silica. Thus, to aid in the removal of any ionic silica, the filtering may include use of strong base ion exchange, to provide very high-quality recovered water for reuse in multiple locations within an operating plant.

In one or more embodiments, the method further includes storing the recovered water. The storing may occur in storage tank 110. In one or more embodiments, the method further includes monitoring the water to determine the overall water quality, including microbiological analysis and measurement of parameters. The monitoring may occur after the filtering, for example in storage tank 110 or in another part of system 100 downstream of filter 104. The parameters may include one or more of conductivity, pH, hardness, and alkalinity, amount of dissolved oxygen, amount of total dissolved solids, and amount of ionic silica.

In one or more embodiments, the recovered water is sufficiently reduced in one or more impurities, that is of sufficiently high purity, for reuse. In one or more embodiments, the water is reduced in impurities by between about 60% and about 95%, for example between about 80% and about 95%.

In one or more embodiments, the method further includes chemical treating by adding to the recovered water one or more of a corrosion inhibitor, an oxidizing biocide, a non-oxidizing biocide, and a scale inhibitor. The chemical treating may occur in chemical treatment subsystem 112. The chemical treating may depend on the use of the recovered water. For closed loop cooling medium, chemical treating may include injecting nitrite corrosion inhibitors. For fire and utility system water, chemical treating may include injecting oxidizing biocide for microbiological control. For open loop cooling medium, chemical treating may include injecting one or more of scale inhibitor, non-oxidizing biocide and corrosion inhibitor.

In one or more embodiments, the method further includes reusing the recovered water. The reusing may include recycling the recovered water to at least one of the oil or more boilers. The recovered water may be subsequently used in utility operation of oil and gas facilities such as closed loop cooling medium, boiler feedwater make-up, fire and utility system water, and the like. The recovered water be used in multiple plant operation such as boiler make-up water, closed loop cooling medium, fire and utility system water, open loop cooling medium and other plant needs such as hydrotesting and cleaning.

In one or more embodiments, the solids concentration in water within the one or more boilers is controlled by operating blowdown as described herein. The one or more boilers may be operated with a level ranging from 1% and about 5%, for example between a lower limit of about 1%, 2%, or 3% and an upper limit of about 3%, 4%, or 5%, where any lower limit may be combined with any mathematically compatible upper limit. The blowdown may be continuous. A level for from about 1% to about 2% continuous blowdown corresponds to a cycle of concentration range of about to about 100. As a result, large plants with multiple combustion boilers and heat recovery steam generators may generate significant blowdown water quantities. When the recovered water is reused, this generates efficiency and cost savings.

### EXAMPLES

### Example 1—Comparative Example

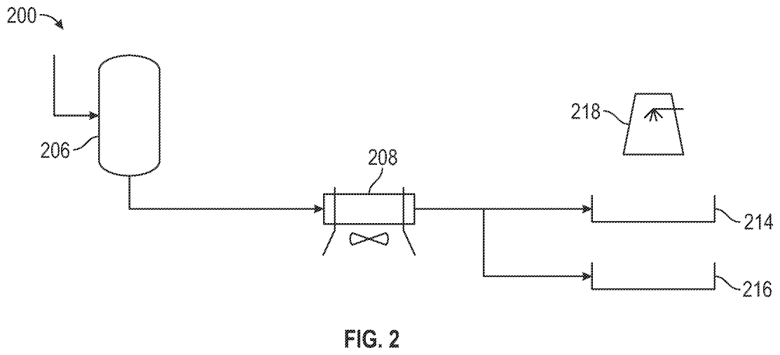

FIG. 2 illustrates a comparative conventional design of blowdown treatment. FIG. 2 shows blowdown treatment system 100 including separator 206, cooler 208, cooling water basin 214, and sump 216, and cooling tower 218. The design of FIG. 2 routes blowdown water into sump 216. Sump 216 receives water from many sources. The water is monitored with a pH analyzer, which auto-pumps fluid to neutralize the water. Typically, the water will be basic and will require neutralization before being discharged to either disposal or evaporation pits.

The quality of the CBD water was analyzed. The CBD water had total dissolved solids (“TDS”), with trace chemical additives, (dependent upon boiler pressure and blowdown rates).

CBD water from a gas plant was analyzed for CBD from a high pressure boiler. The CBD water was repetitively sampled. The pH of the sampled water was between 9.5 and 10. The conductivity of the sampled water was less than 20 micro Siemens per centimeter (“μS/cm”). The amount of iron in the sampled water was less than 2 parts per million (“ppm”). The amount of total dissolved solids (“TDS”) in the sampled water was 13 ppm. The amount of silica as SiO₂ in the sampled water was less than 2.5 ppm. The amount of dissolved oxygen as O₂ in the sampled water was negligible (as used herein, “negligible” means below about 7 parts per billion (ppb)). The amount of phosphate in the sampled water was 20-30 ppm.

CBD water from a gas plant was analyzed for CBD from a heat recovery steam generator (“HRSG”). The CBD water was repetitively sampled. The pH of the sampled water was between 9.5 and 10.5. The conductivity of the sampled water was less than 20 μS/cm. The amount of iron in the sampled water was less than 2 ppm. The amount of total dissolved solids in the sampled water was 10 ppm. The amount of silica as SiO₂ in the sampled water was less than 2 ppm. The amount of dissolved oxygen as O₂ in the sampled water was negligible. The amount of phosphate in the sampled water was 10-15 ppm.

### Example 2—Prophetic Example

Improved CBD water quality is contemplated using the design of FIG. 1, as compared to using the design of FIG. 2. The enhanced feedwater resulting from use of the design of FIG. 2 will be of higher quality than that of Example 1.

CBD water from a gas plant will analyzed for CBD from a high pressure boiler. The CBD water will be repetitively sampled. The pH of the sampled water will be from 9.5 to 10. The conductivity of the sampled water will be less than 20 μS/cm. The amount of iron in the sampled water will be less than 2 ppm. The amount of total dissolved solids (“TDS”) in the sampled water will be from 0 to 50 ppm. The amount of silica as SiO₂ in the sampled water will be less than 2 ppm. The amount of dissolved oxygen as O₂ in the sampled water will be negligible. The amount of phosphate in the sampled water will range from 5 to 20 ppm.

CBD water from a gas plant will analyzed for CBD from a heat recovery steam generator (“HRSG”). The CBD water will be repetitively sampled. The pH of the sampled water will be from 9.5 to 10.5. The conductivity of the sampled water will be less than 20 μS/cm. The amount of iron in the sampled water will be less than 2 ppm. The amount of total dissolved solids (“TDS”) in the sampled water will be from 0 to 15. The amount of silica as SiO₂ in the sampled water will be less than 2 ppm. The amount of dissolved oxygen as O₂ in the sampled water will be negligible. The amount of phosphate in the sampled water will range from 10 to 15 ppm.

### Example 3—Comparative Example

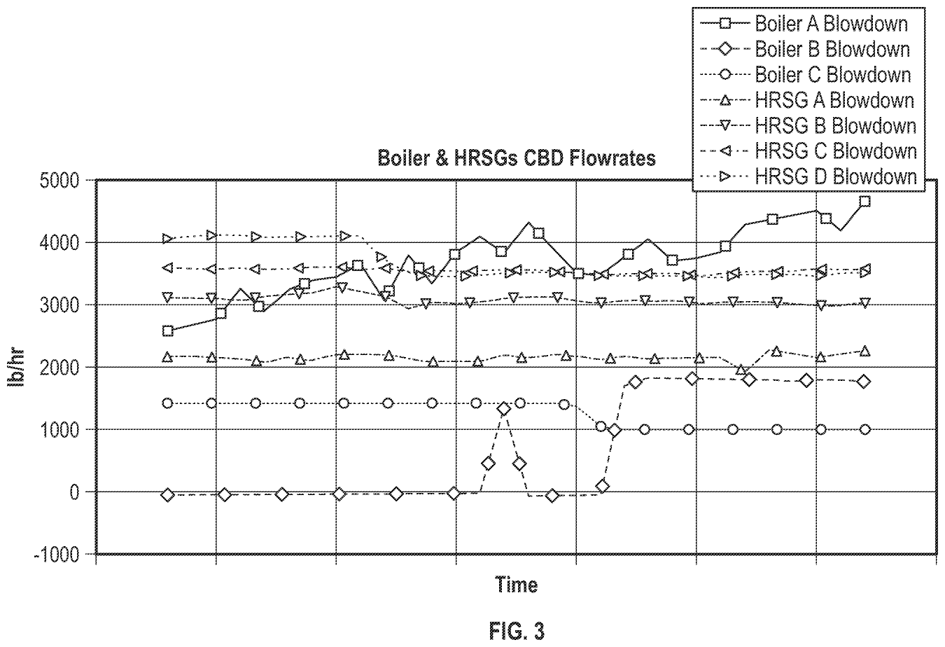

FIG. 3. illustrates trending of CBD discharge from a gas plant. FIG. 3 shows flow rates of blowdown water from the gas plant. The blowdown water is treated by the system of the design of FIG. 2. The flowrates shown in FIG. 3 result in significant waste.

### Example 4—Prophetic Example

Reduced blowdown water waste is contemplated using the design of FIG. 1, as compared to the design of FIG. 2. The blowdown water of the 3 high pressure boilers, boilers A, B, and C, and of 4 HRSG, HRSG A, B, C, and D, will be received by a blowdown treatment system of the design in FIG. 1. The recovered water obtained by microwaving and filtering the blowdown water is reused rather than wasted.

Embodiments of the present disclosure may provide at least one of the following advantages. Embodiments of the present disclosure solve challenges associated with blowdown recycle and reuse to produce treated blowdown that can be used in multiple plant operation such as boiler make-up water, closed loop cooling medium, fire and utility system water, open loop cooling medium and other plant needs such as hydrotesting and cleaning. Embodiments of the present disclosure have the advantage of the avoidance of blowdown disposal, thereby eliminating chemical injection and environmental consequences. Embodiments of the present disclosure have the advantage of the avoidance of other processed such as coagulation-precipitation and evaporators thereby eliminating expensive chemical addition such as lime and other metal hydroxides and/or major capital expenditures. Embodiments of the present disclosure have the advantage of economical use due to the significant reduction of raw and feedwater water consumption.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for treating blowdown water derived from one or more boilers, comprising:
a microwave reactor configured to receive the blowdown water;
a cooler in fluid communication with the microwave reactor; and
a filter in fluid communication with the cooler.

2. The system of claim 1, wherein the system is in continuous fluid communication with the boiler.

3. The system of claim 1, wherein the cooler is a blowdown cooler.

4. The system of claim 1, wherein the filter is an ion exchange filter.

5. The system of claim 1, further comprising a blowdown separator configured to receive the blowdown water from the one or more boilers, wherein the microwave reactor is configured to receive the blowdown water from the blowdown separator.

6. The system of claim 1, further comprising a storage tank.

7. The system of claim 1, wherein the one or more boilers comprise one or more combustion boilers and one or more heat recovery steam generators.

8. A method for treating water, comprising:
receiving blowdown water from one or more boilers, wherein the blowdown water comprises an impurity;
exposing the blowdown to microwave radiation to produce a vapor;
cooling the vapor to produce microwaved water; and
filtering the microwaved water to produce recovered water, wherein the recovered water comprises a reduced amount of the impurity relative to the blowdown water.

9. The method of claim 8, wherein the exposing precipitates a portion of the impurity.

10. The method of claim 8, wherein the exposing destroys bacteria in the impurity.

11. The method of claim 8, wherein the filtering removes a portion of the impurity.

12. The method of claim 8, wherein the receiving is continuous.

13. The method of claim 8, further comprising storing the recovered water.

14. The method of claim 8, further comprising reusing the recovered water.

15. The method of claim 14, wherein the reusing comprising recycling the recovered water to at least one of the oil or more boilers.

16. The method of claim 8, further comprising adding to the recovered water one or more of a corrosion inhibitor, an oxidizing biocide, a non-oxidizing biocide, and a scale inhibitor.

17. The method of claim 8, wherein the impurity is selected from the group consisting of an iron salts, ionic silica, a phosphate scale inhibitor, a polymeric conditioner, a bacteria, and combinations thereof.

18. The method of claim 8, wherein the one or more boilers comprise one or more combustion boilers and one or more heat recovery steam generators.

19. A method for treating water, comprising:
continuously removing blowdown water from a boiler system comprising one or more combustion boilers and one or more heat recovery steam generators, wherein the boiler blowdown water comprises wherein the blowdown water comprises impurities selected from the group consisting of iron salts, ionic silica, a phosphate scale inhibitor, a polymeric conditioner, bacteria, and combinations thereof;
exposing the blowdown water in a microwave reactor to microwave radiation to precipitate a portion of the impurities and produce a vapor;
cooling the vapor in blowdown cooler to produce microwaved water; and
filtering the microwaved water in an ion exchange filter to filter another portion of the impurities and produce recovered water, wherein the recovered water comprises a reduced amount of the impurities;
storing the recovered water;
adding to the recovered water one or more of a corrosion inhibitor, an oxidizing biocide, a non-oxidizing biocide, and a scale inhibitor; and
recycling the recovered water to the boiler system.
